(19) United States
(12) Patent Application Publication
(10) Pub. No.: US 2011/0159185 A1
(43) Pub. Date: Jun. 30, 2011

(54) COMPOSITE WOOD PROCESSING METHOD AND EQUIPMENT FOR UNIDIRECTIONALLY PRESSURIZING AND FILLING WOOD

(76) Inventor: Rung-Tai FAN, Junghe City (TW)

(21) Appl. No.: 12/650,290

(22) Filed: Dec. 30, 2009

(51) Int. Cl. B05D 1/18; B05C 3/02

(52) U.S. Cl. 427/254; 118/50; 427/440; 118/715

(57) ABSTRACT

The present invention discloses a composite wood processing method and equipment for unidirectionally pressurizing and filling wood. Original ducts of wood which transport water and nutrients are used primarily to make wood into the composite wood by a unidirectional pressurization method. The processing method puts the wood longitudinally into a pressure vessel, allowing front end parts of the wood to be connected with atmosphere. Next, the wood is sealed with the pressure vessel and a solution is pressurized and filled into the pressure vessel, such that the solution can enter into the wood through the ducts of wood that transport water and nutrients. The composite wood processing method utilizes the original ducts of wood transporting water and nutrients; therefore, the composite wood can be formed by lower pressure and with a saving of energy, thereby having multiple advantages of fast processing, stability, labor saving and time saving.

### BACKGROUND OF THE INVENTION

a) Field of the Invention

The present invention relates to a composite wood processing method and equipment for unidirectionally pressurizing and filling wood, by which natural wood, including bamboo, which is suitable for acting as a building material, is made into the composite wood having fire-proof and preservation functions and is thus particularly suitable for an application in markets of the building materials.

b) Description of the Prior Art

For a conventional wood preservation and fire-proofing treatment, wood is put into a pool or a container, and then a solution, such as a preservative liquid or a fire-proofing liquid, is filled in, allowing the solution to enter into the wood naturally. The treatment is accomplished when the wood has adsorbed the solution to saturation. This traditional processing method requires that the wood is immersed in the solution for a very long time and cannot be used for mass production; therefore, it is not economical.

For another processing method, wood is put into a pressure tank which can sustain with high pressure and then a solution is added into the pressure tank, followed by carrying out a pressurization process, thereby speeding up osmosis of the solution into the wood. In the process, this method requires exerting very large pressure to the pressure tank (a pressure value of about 10˜30 kg/cm²); therefore, an equipment cost of the pressure tank is high and it is also very dangerous to work under this kind of condition. As a result, a production cost is very high and the processed wood will be rather expensive, which is often complained by users.

In reality, it can be found after deeply studying properties of wood that when a tree is growing, a trunk is provided with a lot of vascular tissues and conductive tissues which are assembled by tracheary elements arranged longitudinally to transport water and nutrients, and the vascular tissues and the conductive tissues in the trunk will not be damaged after making the wood. On the contrary, the property of longitudinal arrangement intensifies transversal resistance to pressure.

As a result, if the original ducts of wood for transporting water and nutrients can be used to make wood into the composite wood by unidirectional pressurization, then the aforementioned shortcomings of the prior art can be overcome, allowing the processed composite wood to have the fire-proof and preservation functions; wood intensity can be improved; a lifetime of usage can be extended; an object of wide application in the markets of building materials can be achieved; and multiple advantages of fast processing, stability, labor saving and time saving are available.

### SUMMARY OF THE INVENTION

To achieve the aforementioned objects, the composite wood processing equipment for unidirectionally pressurizing and filling wood, according to the present invention, includes a pressure vessel and a solution pressurization device. An interior of the pressure vessel allows at least one piece of wood to be put into, a side of the pressure vessel is provided with openings, an amount of which being equal to that of the wood and the other side of the pressure vessel is connected to the solution pressurization device to fill the solution into the pressure vessel. Each opening of the said pressure vessel is provided with a plug, an outline of the plug fits with shape of the opening of the pressure vessel to close the opening, and an inner rim of the plug is provided with a through-hole to seal with an outer rim of the wood, such that a front end part of the wood can be connected with atmosphere through the through-hole of the plug.

By the aforementioned equipment, when the solution pressurization device pressurizes and fills the solution into the pressure vessel, as the front end parts of the wood are connected with the atmosphere through the through-holes of the plugs, negative pressure will be formed at the front end parts of the wood by the pressurized solution in the pressure vessel, allowing the solution to exert pressure from rear end parts to the front end parts of the wood. Thus, through the original ducts that transport water and nutrients, the solution can be quickly permeated into the wood from the rear end parts toward the front end parts of the wood.

It is worth of mentioned that the aforementioned solution is a gaseous or liquid solution added by a fine grain material (a grain size of smaller than 0.002 mm). The additive includes clay such as kaolinite, illite or montmorillonite, a nano material and a natural or chemical fire-proof agent or preservative agent, which allows the wood to have the fire-proof and preservation functions when the composite wood is formed after the solution has permeated and been adsorbed in wood tissues.

In summary, the method of the present invention puts the wood longitudinally into the pressure vessel, seals the wood with the pressure vessel and pressurizes and fills the solution into the pressure vessel after the front end parts of the wood have been connected with the atmosphere, allowing the solution to enter into the wood through the ducts of wood that transport water and nutrients from the rear end parts of the wood.

As the aforementioned composite wood processing method utilizes the original ducts of wood that transport water and nutrients, the composite wood can be formed by lower pressure and with a saving of energy. In addition, the processed composite wood can be provided with the fire-proof and preservation functions, the wood intensity can be improved and the lifetime of usage can be extended, thereby achieving the object of wide application in the markets of building materials and having the multiple advantages of fast processing, stability, labor saving and time saving.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural schematic view of composite wood processing equipment of the present invention.

FIG. 2 shows a schematic view of a first embodiment of the composite wood processing equipment and method, according to the present invention.

FIG. 3 shows a schematic view of a second embodiment of the composite wood processing equipment and method, according to the present invention.

FIG. 4 shows a schematic view of a third embodiment of the composite wood processing equipment and method, according to the present invention.

FIG. 5 shows a schematic view of an embodiment that plural pieces of wood are processed simultaneously by the composite wood processing equipment of the present invention.

### DETAILED DESCRIPTION OF THE PREFERRED EMBODIMENTS

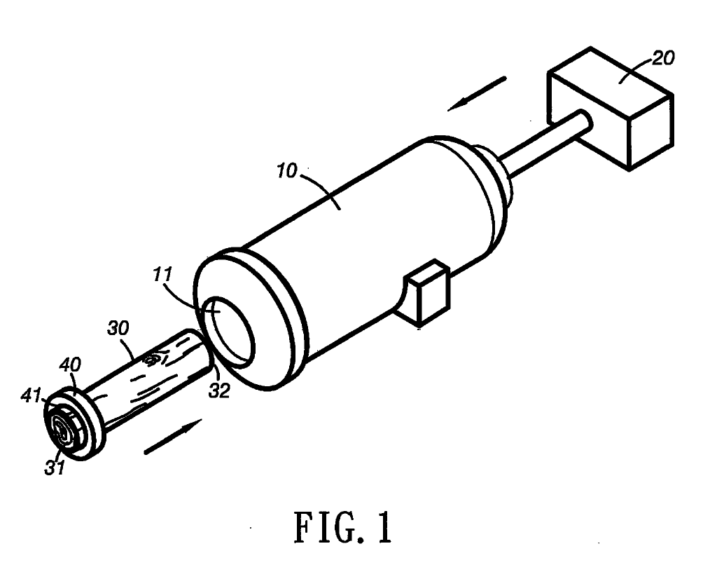

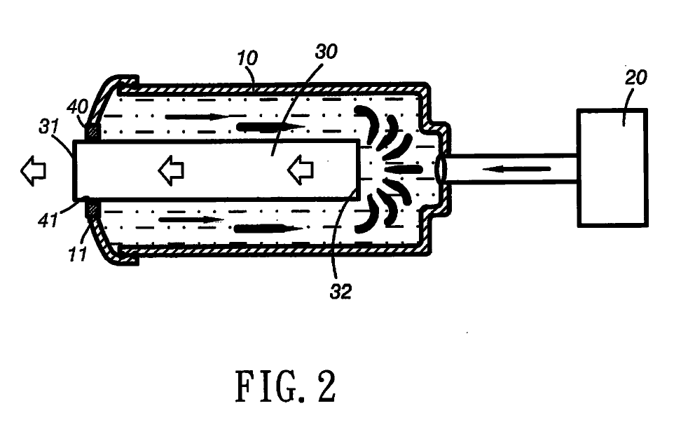

Referring to FIG. 1 and FIG. 2, composite wood processing equipment for unidirectionally pressurizing and filling wood, according to the present invention, comprises a pressure vessel 10 and a solution pressurization device 20. An interior of the pressure vessel 10 provides for at least one piece of wood 30 (natural wood including bamboo) to be put into longitudinally; a side of the pressure vessel 10 is provided with openings 11, an amount of which being equal to that of the wood 30; and the other side of the pressure vessel 10 is connected to the solution pressurization device 20 which fills the solution into the pressure vessel 10.

Each opening 11 of the said pressure vessel 10 is provided with a plug 40, an outline of the plug 40 fits with shape of the opening 11 of the pressure vessel 10 to close the opening 11, an inner rim of the plug 40 is provided with a through-hole 41 and an inner rim of the through-hole 41 can be sealed with an outer rim of the wood 30, allowing a front end part 31 of the wood 30 to be connected with atmosphere through the through-hole 41 of the plug 40. In implementation, the plug 40 can be made by rubber or soft plastic, whereas the method for sealing the inner rim of the through-hole 41 with the outer rim of the wood 30 can be achieved by sealing seams with water-proof glue or a washer, fitting with shape of the wood 30.

By the aforementioned equipment, when the solution pressurization device 20 pressurizes and fills the solution into the pressure vessel 10, as the front end parts 31 of the wood 30 are connected with the atmosphere through the through-holes 41 of the plugs 40, negative pressure will be formed at the front end parts 31 of the wood 30 by the solution that is pressurized in the pressure vessel 10, allowing the solution in the pressure vessel 10 to exert pressure from rear end parts 32 of the wood 30 to the front end parts 31. As a result, the solution can be quickly permeated into the wood 30 through original ducts which transport water and nutrients from the rear end parts 32 of the wood 30 toward the front end parts 31 of the wood 30.

On the other hand, the aforementioned solution is a solution added by a natural or chemical fire-proof agent or preservative agent, including clay such as kaolinite, illite or montmorillonite, or a nano-material. Also, the solution is a gaseous or liquid solution added by a fine grain material. The composite wood which is formed after the solution has permeated and been absorbed into tissues of the wood 30 can be provided with fire-proof and preservation functions.

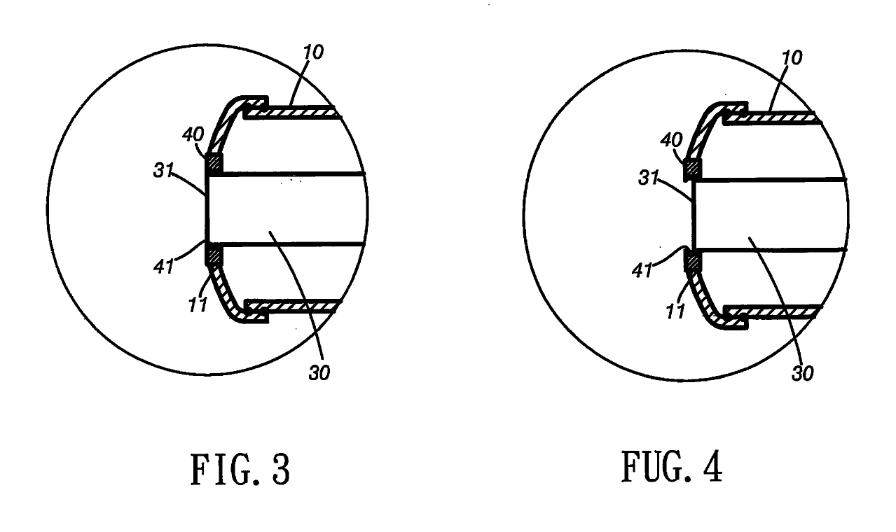

In the drawings disclosed above, the front end parts 31 of the wood 30 are exposed out of the through-holes 41 of the plugs 40. When implementing, it is only required that an outer part of the front end part 31 of the wood 30 is opened to the atmosphere. For example, as shown in FIG. 3, the front end part 31 of the wood 30 is aligned with a front end of the through-hole 41 of the plug 40; whereas, in FIG. 4, the front end part 31 of the wood 30 is indented in the front end of the through-hole 41 of the plug 40. Both are feasible embodiments.

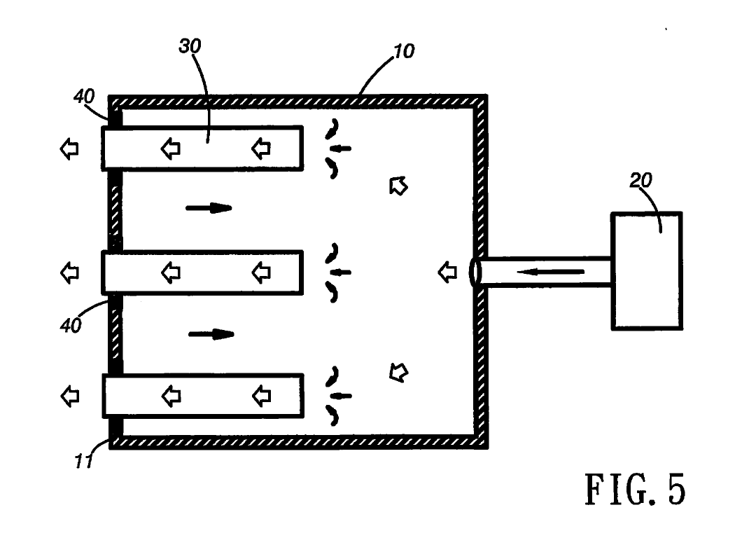

Referring to FIG. 5, when implementing the composite wood processing equipment for unidirectionally pressurizing and filling wood, it is feasible to provide plural openings 11 for the pressure vessel 10, allowing the wood 30 in a same amount to be put into the pressure vessel 10. Next, the plugs 40 in the same amount are used to close each opening 11 of the pressure vessel 10, so as to pressurize and fill the plural pieces of wood 30 unidirectionally at a same time.

In summary, as shown in FIGS. 1 to 5, the composite wood processing method for unidirectionally pressurizing and filling wood, according to the present invention, comprises following steps:

Step 1—putting the wood 30 longitudinally into the pressure vessel 10, allowing the front end part 31 of the wood 30 to be connected with the atmosphere;

Step 2—sealing the wood 30 with the pressure vessel 10 and then pressurizing and filling the solution into the pressure vessel 10;

Step 3—the pressurized solution entering into the wood 30 through the ducts of wood 30 that transport water and nutrients from the rear end part 32 of the wood 30, which accomplishes the unidirectional pressurization and filling of wood.

In the aforementioned implementation steps, the structure of pressure vessel 10, the sealing of the wood 30 with the pressure vessel 10, and the pressurization and filling of the solution into the pressure vessel 10 are the same as those disclosed above; thus, no further description is needed.

As the aforementioned composite wood processing method utilizes the original ducts of wood that transport water and nutrients to permeate the solution into the wood, the composite wood can be formed by lower pressure and with a saving of energy. Accordingly, an equipment cost is cheaper, the processed composite wood can be provided with the fire-proof and preservation functions, wood intensity can be improved and a lifetime of usage can be extended, thereby achieving an object of wide application in the markets of building materials, which is provided with multiple advantages of fast processing, stability, labor saving and time saving, in comparison with the prior art.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. Composite wood equipment for unidirectionally pressurizing and filling wood, comprising a pressure vessel and a solution pressurization device, wherein an interior of the pressure vessel allows at least one piece of wood to be put into, a side of the pressure vessel is provided with openings, an amount of the openings being equal to that of the wood, and the other side of the pressure vessel is connected with the solution pressurization device, allowing the solution pressurization device to pressurize and fill the solution into the pressure vessel; each opening of the pressure vessel being provided with a plug, an outer rim of the plug closing the opening of the pressure vessel, an inner rim of the plug being provided with a through-hole and an inner rim of the through-hole being sealed with an outer rim of the wood, thereby forming negative pressure at front end parts of the wood through connection of the through-holes of the plugs with atmosphere, allowing the solution in the pressure vessel to be quickly permeated into the wood through original ducts of wood that transport water and nutrients, from rear end parts of the wood.

2. The composite wood equipment for unidirectionally pressurizing and filling wood, according to claim 1, wherein the wood includes bamboo.

3. The composite wood equipment for unidirectionally pressurizing and filling wood, according to claim 1, wherein the inner rims of the through-holes are sealed with the outer rims of the wood by water-proof glue or washers.

4. The composite wood equipment for unidirectionally pressurizing and filling wood, according to claim 1, wherein the front end parts of the wood are exposed out of the through-holes of the plugs.

5. The composite wood equipment for unidirectionally pressurizing and filling wood, according to claim 1, wherein the front end parts of the wood are aligned with front ends of the through-holes of the plugs.

6. The composite wood equipment for unidirectionally pressurizing and filling wood, according to claim 1, wherein the front end parts of the wood are indented in front ends of the through-holes of the plugs.

7. The composite wood equipment for unidirectionally pressurizing and filling wood, according to claim 1, wherein the solution is a gaseous or liquid solution added by a fine grain material and the additive includes clay such as kaolinite, illite or montmorillonite, a nano material and a natural or chemical fire-proof agent or preservative agent.

8. A composite wood processing method for unidirectionally pressurizing and filling wood, comprising following steps:
step 1—putting a piece of wood longitudinally in a pressure vessel, allowing a front end part of the wood to be connected with atmosphere;
step 2—sealing the wood with the pressure vessel, and pressurizing and filling a solution into the pressure vessel;
step 3—the pressurized solution entering into the wood through ducts of wood which transport water and nutrients, from a rear end part of the wood.

9. The composite wood processing method for unidirectionally pressurizing and filling wood, according to claim 8, wherein a side of the pressure vessel is provided with openings, an amount of the openings being equal to that of the wood, allowing the front end parts of the wood to be connected with the atmosphere.

10. The composite wood processing method for unidirectionally pressurizing and filling wood, according to claim 8, wherein each opening of the pressure vessel is provided with a plug, an outer rim of the plug closes the opening of the pressure vessel, an inner rim of the plug is provided with a through-hole, and an inner rim of the through-hole is sealed with an outer rim of the wood, allowing the front end parts of the wood to be connected with the atmosphere through the through-holes of the plugs.

11. The composite wood processing method for unidirectionally pressurizing and filling wood, according to claim 8, wherein the solution is pressurized and filled into the pressure vessel by a solution pressurization device.

12. The composite wood processing method for unidirectionally pressurizing and filling wood, according to claim 8, wherein the solution is a gaseous or liquid solution added by a fine grain material, and the additive includes clay such as kaolinite, illite or montmorillonite, a nano material and a natural or chemical fire-proof agent or preservative agent.
